(19) United States
(12) Patent Application Publication
(10) Pub. No.: US 2025/0201876 A1
(43) Pub. Date: Jun. 19, 2025

(54) ADAPTIVE PURGING FOR A FUEL CELL SYSTEM

(71) Applicant: Intelligent Energy Limited, Loughborough, Leicestershire (GB)

(72) Inventor: SCOTT BAIRD, Loughborough (GB)

(73) Assignee: Intelligent Energy Limited, Loughborough, Leicestershire (GB)

(21) Appl. No.: 18/861,842

(22) PCT Filed: Jun. 7, 2023
(86) PCT No.: PCT/US2023/024725

§ 371 Date: Oct. 30, 2024

(30) Foreign Application Priority Data
Sep. 13, 2022 (GB) 2213374.8

(51) Int. Cl. H01M 8/04223; H01M 8/0432; H01M 8/04492; H01M 8/04537; H01M 8/04746

(52) U.S. Cl. CPC H01M 8/04231; H01M 8/0432; H01M 8/04492; H01M 8/04544; H01M 8/04574; H01M 8/04753

(57) ABSTRACT

Disclosed herein are aspects of an adaptive purge technique for purging fuel cells adjusts the time delay between subsequent purges based in part on one or more parameters of the fuel cells. A difference between two like parameters is measured before and after actuation of a valve used to permit entry of a purge gas. The degree of difference between the two parameters is used to determine a time delay, i.e., a time at which the valve should again be actuated to permit the next purge of the fuel cell. In additional to the time delay, the parameters may be used to determine a time interval, or duration, in which the valve is actuated to remain open during a purge event.

### TECHNICAL FIELD

This application is the US National Phase of International Application No. PCT/US2023/024725, filed Jun. 7, 2023, titled, ADAPTIVE PURGING FOR A FUEL CELL SYSTEM, which claims priority to UK Patent Application No. 2213374.8, filed on Sep. 13, 2022, the disclosure of which is incorporated by reference herein in its entirety as if fully set forth herein.

This application is directed to fuel cell systems, and more particularly, to adaptively managing a control valve for purging one or more fuel cells of a fuel cell system.

### BACKGROUND

Conventional electrochemical fuel cells convert fuel and oxidant into electrical energy and a reaction product. A common type of electrochemical fuel cell includes a membrane electrode assembly (MEA), which includes a polymeric ion (proton) transfer membrane between an anode and a cathode flow paths or gas diffusion structures. The fuel, such as hydrogen, and the oxidant, such as oxygen from air, are passed over respective sides of the MEA to generate electrical energy and water as the reaction product. A stack may be formed including a number of such fuel cells arranged with separate anode and cathode fluid flow paths. Such a stack is typically in the form of a block including numerous individual fuel cell plates held together by end plates at either end of the stack.

It is important that the polymeric ion transfer membrane remains hydrated for efficient operation. It is also important that the temperature of the stack is controlled. Thus, coolant may be supplied to the stack for cooling and/or hydration. It may be necessary at particular times or periodically to purge the flow paths or gas diffusion structures of the fuel cell of coolant, contaminants, or reaction by-products using a purge gas.

Periodically, purging (i.e., removing) the water and other gases from the fuel cells should be performed. The removal gas, which may include the fuel (hydrogen for example) flows through the anode flow path to remove the water and gases from the fuel cell. Conventional fuel cells are set to provide this removal process at a specified time regardless of whether the removal is necessary at that particular time. This can result in inefficient use of gases used to remove the water, particularly when the gas is also used to generate electrical energy.

### DISCLOSURE

According to one aspect of the present disclosure there is provided a fuel cell system, comprising: a fuel cell assembly comprising an anode exhaust and a fuel cell; a valve configured to exhaust a purge gas from the anode exhaust; and a valve controller configured to: prior to a first purge of the fuel cell with the purge gas, obtain a first parameter of the fuel cell; subsequent to the first purge, obtain a second parameter of the fuel cell; obtain a difference between the first parameter and the second parameter; and, determine, based on the difference, a time delay for a second purge subsequent to the first purge.

According to another aspect of the present disclosure there is provided a fuel cell system, comprising: a fuel cell assembly comprising an anode exhaust and a fuel cell; a valve configured to exhaust a purge gas from the anode exhaust; and a valve controller configured to: prior to a first purge of the fuel cell with the purge gas, obtain a first parameter of the fuel cell; subsequent to the first purge, obtain a second parameter of the fuel cell; obtain a difference between the first parameter and the second parameter; and, determine, based on the difference, a purge duration in which the valve remains open for a second purge subsequent to the first purge.

According to a yet further aspect of the present disclosure there is provided a fuel cell system, comprising: a fuel cell assembly comprising an anode exhaust and a fuel cell; a valve configured to exhaust a purge gas from the anode exhaust; and a valve controller configured to: prior to a first purge of the fuel cell with the purge gas, obtain a first parameter of the fuel cell; subsequent to the first purge, obtain a second parameter of the fuel cell; obtain a difference between the first parameter and the second parameter; and, perform, based on the difference, a purge cluster that includes a series of opening and subsequently closing the valve for a predetermined number of times.

In any of the above-described aspects of the present disclosure, the first parameter may comprise a first output voltage, a first temperature, a first humidity or a first current of the fuel cell, and the second parameter may comprise a respective second output voltage, second temperature, second humidity or second current of the fuel cell. In some aspects, the first parameter may comprise a first altitude or a first humidity of the fuel cell, and the second parameter may comprise a second altitude or a second humidity, respectively of the fuel cell.

The present disclosure in some aspects also describes an adaptive purge technique for purging fuel cells which adjusts the time delay between subsequent purges based in part on one or more parameters of the fuel cells. A difference between two like parameters is measured before and after actuation of a valve used to permit passage of a purge gas. The degree of difference between the two parameters is used to determine a time delay, i.e., a time at which the valve should again be actuated to permit the next purge of the fuel cell. In additional to the time delay, the parameters may be used to determine a time interval, or duration, in which the valve is actuated to remain open during a purge event. Alternatively, or in combination, a purge cluster can also be implemented by opening and closing the valve for a predetermined number of times.

### DESCRIPTION OF THE DRAWINGS

Certain features of the subject technology are set forth in the appended claims. However, for purpose of explanation, several exemplars of the subject technology are set forth in the following figures.

FIG. 1 illustrates a schematic diagram of a fuel cell system including a fuel cell assembly, exhaust assembly and a control valve, in accordance with aspects of the present disclosure.

FIGS. 2A and 2B illustrate an example valve that can be actuated in two operating positions, in accordance with aspects of the present disclosure.

FIG. 3 illustrates an example valve that can be actuated in two operating positions, in accordance with aspects of the present disclosure.

FIG. 4 illustrates a schematic diagram of an alternate fuel cell system, in accordance with aspects of the present disclosure.

FIG. 5 illustrates a schematic diagram of an alternate fuel cell system with multiple valves, in accordance with aspects of the present disclosure.

FIG. 6 illustrates a method for adaptively purging a fuel cell, in accordance with aspects of the present disclosure.

FIG. 7 illustrates an alternate method for adaptively purging a fuel cell, in accordance with aspects of the present disclosure.

### FURTHER DISCLOSURE

The disclosure set forth below is intended as a description of various configurations of the subject technology and is not intended to represent the only configurations in which the subject technology may be practiced. The appended drawings are incorporated herein and constitute a part of the detailed description. The disclosure includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

The subject technology is directed to adaptively purging fuel cells based on various selected parameters of the fuel cells. For example, a time delay, or purge time delay, between actuation (e.g., opening) of a valve can vary based in part upon a difference between two measured parameters. In particular, the degree of difference (e.g., greater difference or lesser difference) between the two measured parameters is used by a valve controller to determine when to actuate the valve for a subsequent purge event. The “difference” described herein may include an absolute value of the difference. Beneficially, actuation of the valve occurs when needed to purge the fuel cell(s), rather than at predetermined time intervals when purging may not be necessary.

Several parameter can be selected to determine an adaptive purge. As non-limiting examples, the parameters may include voltage, temperature, electrical current, altitude, humidity (of incoming air), gas quality, and hydration. In one exemplary implementation, the voltage output of a fuel cell is measured prior to opening a valve to purge the fuel cell. The voltage output of the fuel cell is again measured after opening the valve. The delta, or difference, between the two measured voltages can be used to determine the time delay used for a subsequent valve opening (including the next valve opening) to purge the fuel cell. In this regard, when the measured voltage output difference is relatively high (e.g., 20 millivolts (mV)), the time delay may be relatively short (e.g., 30 seconds(s)). Conversely, when the measured voltage output difference is relatively low (e.g., 5 mV), the time delay may be relatively short (e.g., 120 s). Accordingly, the time delay can be inversely proportional with respect to the difference between the measured parameters.

In addition to the adaptive purge time delay between valve actuation events for purging, an additional time parameter may be integrated. For example, the time the valve is open (e.g., time between opening and closing), representing a purge duration, can vary based in part upon the aforementioned parameters. As a result, a fuel cell system can adaptively actuate a valve in a manner that not only to adjust the time between subsequent valve openings, but can also adjust the time the valve remains open.

The fuel cell systems described herein with adaptive purging capabilities provides several advantages. For example, when the gas used to purge the fuel cell is also used to generate electrical energy, the gas is conserved as adaptive purging is a predictive technique as opposed to traditional technique of predetermined time intervals between purging events.

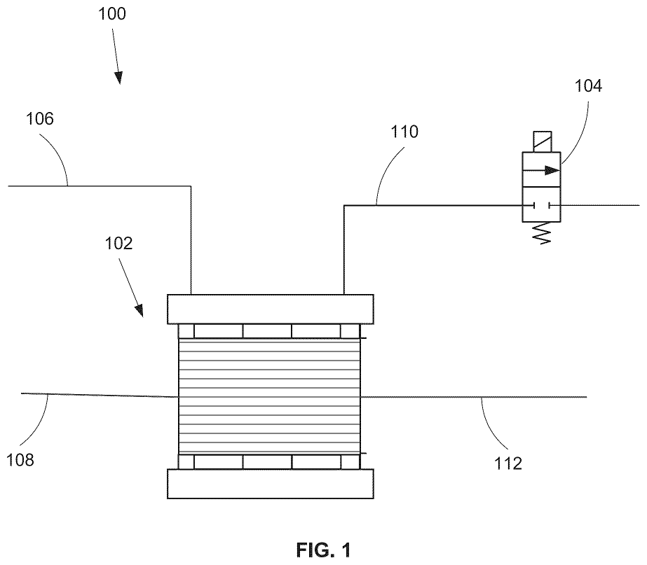

According to aspects of some exemplars, for example as shown in FIG. 1, a fuel cell system 100 comprising a fuel cell assembly 102 and a control valve 104, or simply valve, for controlling the exhaust flow of a purge gas. Thus, the control valve 104 may be referred to as a purge control valve that forms part of an exhaust assembly configured to receive fluids leaving an anode flow path through the fuel cell assembly 102 and a cathode flow path though the fuel cell assembly 102. During a purge operation, a gas, such as a fuel (e.g. hydrogen) flows through the anode flow path to purge the anode flow path of coolant, hydration fluid, contaminants and/or reaction by-products. The control valve 104 is configured to control the purge gas exhaust flow that exhausts from the fuel cell assembly 102.

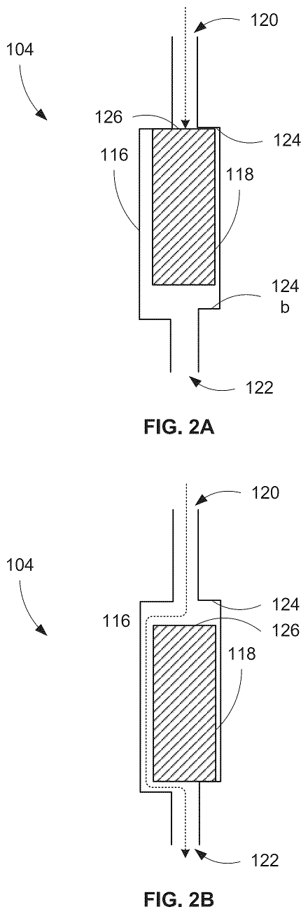

The fuel cell assembly 102 in this example includes a fuel cell stack including multiple proton exchange membrane fuel cells stacked together. The fuel cell assembly 102 is configured to receive a flow of fuel, such as hydrogen, through an anode inlet 106 and a flow of oxidant, such as air, through a cathode inlet 108. An anode exhaust 110 is provided to allow for through flow of any unused fuel and any purge gas. A cathode exhaust outlet 112 is provided to allow for through flow of the oxidant. The control valve 104 is connected to the anode exhaust 110 and includes a two port, two position valve. A schematic diagram of the control valve 104 is shown in FIG. 1 and example valve positions are shown in FIGS. 2A and 2B.

Referring to FIGS. 2A and 2B, the control valve 104 includes a valve body 116 containing a valve member 118. The valve member 118 may be slidably mounted in the valve body 116 moveable between a first position (FIG. 2A) and a second position (FIG. 2B). The valve body 116 includes an inlet port 120 for receiving the purge gas exhausted from the fuel cell assembly 102 (shown in FIG. 1) and an outlet port 122 for providing an outlet for the purge gas.

In the first position (FIG. 2A), the valve member 118 acts to prevent exhausted purge gas (represented by a dotted line) from flowing between the inlet port 120 and the outlet port 122. In the second position (FIG. 2B), the valve member 118 allows the flow of purge gas between the inlet port 120 and the outlet port 122. Thus, the valve member 118 is configured to close the inlet port 120 in its first position and open the inlet port 120 in its second position. In particular, the inlet port 120 includes a valve seat 124 against which a sealing surface 126 of the valve member 118 seals in the first position. When the sealing surface 126 valve member 118 is not engaged with the valve seat 124 (as shown in FIG. 2B), the purge gas is permitted to flow through the control valve 104.

The valve member 118 is biased to the first position by a biasing means, which may include a spring as a non-limiting example. The control valve 104 may include a solenoid valve and thus the valve member 118 may be movable between its first and second position by actuation of a solenoid (not shown) which is configured to move the valve member 118 to the second position against the force of the biasing means.

With reference to FIG. 1, during a purge operation, fuel may flow through the anode flow path of the fuel cell assembly 102. The control valve 104 may be actuated, by way of the solenoid, to move the valve member 118 from the first position to the second position, which may allow the purge gas to flow through the fuel cell assembly 102.

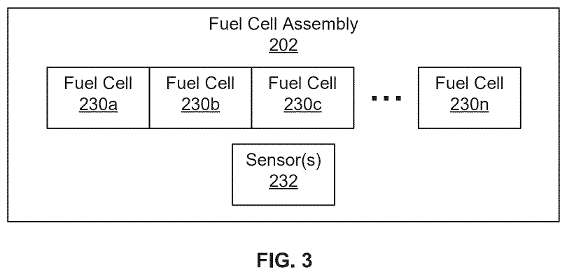

Referring to FIG. 3, a fuel cell assembly 202 includes n fuel cells, with a fuel cell 230a, a fuel cell 230b, a fuel cell 230c, and a fuel cell 230n. In this regard, the fuel cell assembly 202 may include a fuel cell stack composed of fuel cells 230a through 230n. Additionally, the fuel cells 230a and 230n may be referred to as end cells, as the fuel cells 230a and 230n represent the two outermost fuel cells.

Additionally, the fuel cell assembly 202 includes one or more sensors 232 designed to monitor at least one of the fuel cells 230a through 230n. In some exemplars, the one or more sensors 232 includes a voltmeter(s) designed to determine an output voltage of at least one of the fuel cells 230a through 230n. Further, in some exemplars, the one or more sensors 232 includes a temperature sensor(s) designed to measure a temperature least one of the fuel cells 230a through 230n. Still further, in some exemplars, the one or more sensors 232 includes a barometric sensor(s) designed to measure a pressure (e.g., ambient pressure) least one of the fuel cells 230a through 230n. In this regard, the one or more sensors 232 can determine an elevation (i.e., relative to sea level) of the fuel cell assembly 202 based on the measure pressure. Alternative to the barometric sensor, the one or more sensors 232 may include an altimeter used to determine the altitude. Additionally, in some exemplars, the one or more sensors 232 includes a humidity sensor(s) designed to measure relative humidity of air entering at least one of the fuel cells 230a through 230n. Also, in some exemplars, the one or more sensors 232 includes a gas analyzer(s) designed to measure gas composition, which can be used to determine purity/quality of gas in at least one of the fuel cells 230a through 230n. Also, in some exemplars, the one or more sensors 232 includes a hydration sensor designed to measure an amount of liquid in at least one of the fuel cells 230a through 230n.

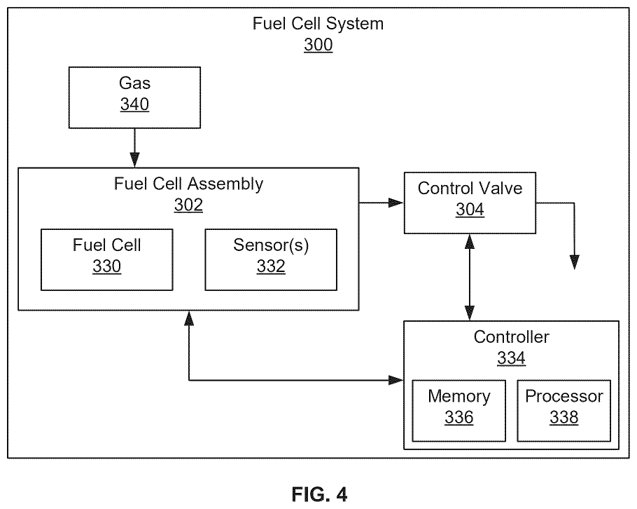

Referring to FIG. 4, a fuel cell system 300 includes a fuel cell assembly 302 and a control valve 304 that is actuated by a controller 334. The fuel cell assembly 302 includes a fuel cell 330 and one or more sensors 332 that monitor the fuel cell 330. The one or more sensors 332 may include any of the aforementioned sensors described herein. Also, as shown, the one or more sensors 332 is/are integrated with the fuel cell assembly 302. However, it should be noted that the one or more sensors 332 can be separate from the fuel cell assembly 302 while still monitoring the fuel cell 330 and in communication with the controller 334.

The controller 334 includes a memory 336 representing one or more memory circuits that store(s) executable code or executable instructions. The controller 334 further includes a processor 338 representing processing circuitry in the form of a central processing unit, a programmable logic circuit, and/or an application-specific integrated circuit. The processor 338 is designed to execute the instructions/code stored on the memory 336. For example, the processor 338 can use instructions stored on the memory 336 to actuate (i.e., open and close) to control valve 304. When the controller 334 opens the control valve 304, a gas 340 passes through the fuel cell assembly 302 to purge the fuel cell 330. The gas 340 may include hydrogen, as a non-limiting example.

Additionally, the processor 338 can be used to send instructions stored on the memory 336 to obtain data (e.g., a numeric value(s)) from the one or more sensors 332. In this regard, the controller 334 can receive the data from the one or more sensors 332 by requesting the data periodically (e.g., on the order of milliseconds or seconds) or continuously receive updated data from the one or more sensors 332. In some exemplars, the controller 334 obtains the data from the one or more sensors 332 before and after actuation of the control valve 304. For example, prior to the controller 334 opening the control valve 304, the controller 334 can obtain data from the one or more sensors 332. Further, after the controller 334 closes the control valve 304, the controller 334 can obtain data (i.e., updated data) from the one or more sensors 332.

In an exemplary exemplar, the one or more sensors 332 includes at least one voltmeter designed to monitor and determine an output voltage of the fuel cell 330. Prior to the controller 334 opening the control valve 304, the controller 334 can obtain an output voltage from the one or more sensors 332. Further, after the controller 334 closes the control valve 304, the controller 334 can an output voltage from the one or more sensors 332. The opening and closing of the control valve 304 represents a purge event.

Using the memory 336 and the processor 338, the controller 334 can determine a difference between the two output voltages, and determine a time delay to provide instructions to the control valve 304 for a subsequent purge event. Put another way, the controller 334 uses the output voltage difference to determine when to initiate the next purge event. The time delay between consecutive purge events may be inversely proportional. For example, the time delay is relatively longer when the output voltage difference is relatively smaller, and conversely, the time delay is relatively shorter when the output voltage difference is relatively greater. This process may include an iterative process that compares the difference between consecutive output voltages at a purge event, and adjusts the time delay for the next purge event. Beneficially, the fuel cell system 300 includes an adaptive purge technique that predicts subsequent purges, which may reduce the number of purge events to conserve the gas 340, or alternatively, increase the number of purge events to more efficiently operate the fuel cell assembly 302 (particularly, the fuel cell 330) to promote increased energy output and/or to limit or prevent damage to the fuel cell assembly 302.

Also, in some exemplars, when then the difference between the two parameters (e.g., difference between two measured output voltages) is below a threshold difference, the controller 334 does not adaptively adjust the time delay. Put another way, the change in time delay is zero seconds for a subsequent purge and the prior time delay is used.

Generally, the foregoing example may be implemented in a similar manner with different sensors. For example, when the one or more sensors 332 includes at least one temperature sensor that monitors and determines a temperature of the fuel cell 330, the controller 334 can obtain a voltage from the one or more sensors 332 both before opening the control valve 304 and after the control valve 304 closes, determine a temperate difference between the two obtained temperatures, and determine a time delay based upon the temperature difference. Alternatively, the measured temperatures may be compared against an ideal set of temperatures on a curve (e.g., bell curve), and the time delay is based upon deviation from the curve.

In another example, when the one or more sensors 332 includes a current meter, the measured current may be compared against a range (e.g., optimal range), and the time delay is based upon deviation from the range.

Other examples of the one or more sensors 332 include a barometric pressure sensor, an altimeter, a humidity sensor, a gas analyzer, and/or a hydration sensor. In a similar manner, the controller 334 can obtain respective data from the alternative examples of the one or more sensors 332 before opening the control valve 304 and after closing the control valve 304, determine a difference between the two obtained data, and determine a time delay based upon the determined difference. The time delay can again be inversely proportional to the determined difference. For example, the time delay between consecutive purge events may decrease when the altitude difference (determined by a barometric sensor or an altimeter) is relatively larger. Similarly, the time delay between consecutive purge events may decrease when the humidity difference (determined by a humidity sensor) is relatively larger.

Alternative to, or in combination with, the time delay between consecutive purge events, the duration of a purge event can be adaptively adjusted. The duration of the purge event may refer to the time between (and including) the opening and subsequent closing of the control valve 304. For example, the controller 334 may use the output voltage difference to determine the duration of the purge event for a subsequent purge event (or events), including the next purge event. By further adaptively controlling the control valve 304 to decrease the purge duration, the gas 340 may be conserved. Alternatively, by further adaptively controlling the control valve 304 to increase the purge duration, the fuel cell assembly 302 (particularly, the fuel cell 330) is operated more efficiently to promote increased energy output, and/or is prevented from damage. In addition to voltmeters, it should be noted that purge duration may be associated with any implementation of the examples of the one or more sensors 332.

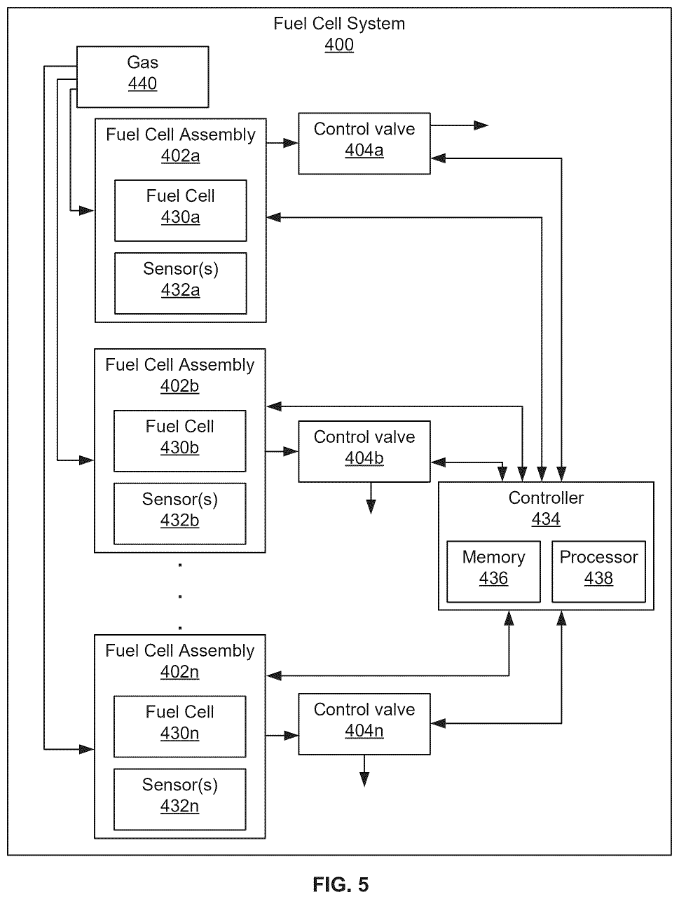

Referring to FIG. 5, a fuel cell system 400 includes multiple fuel cell assemblies. As shown, the fuel cell system 400 includes n fuel cell assemblies and n control valves. A fuel cell assembly 402a, a fuel cell assembly 402b, and a fuel cell assembly 402n are shown. The fuel cell assembly 402a includes a fuel cell 430a and one or more sensors 432a. The fuel cell assembly 402b includes a fuel cell 430b and one or more sensors 432b. The fuel cell assembly 402n includes a fuel cell 430n and one or more sensors 432n. The one or more sensors 432a, 432b, and 432n may include any of the aforementioned sensors described herein.

Also, a control valve 404a, control valve 404b, and control valve 404n are used to permit a gas 440 to purge the fuel cell 430a, the fuel cell 430b, and the fuel cell 430n, respectively. The fuel cell system 400 further includes a controller 434 used to actuate each of the control valves 404a, 404b, and 404n to purge the fuel cells 430a, 430b, and 430n, respectively. Also, as shown, the one or more sensors 432a, 432b, and 432n are integrated with the fuel cell assemblies 402a, 402b, and 402n, respectively. However, it should be noted that the one or more sensors 432a, 432b, and 432n can be separate from the fuel cell assemblies 402a, 402b, and 402n, respectively, while still monitoring the fuel cells 430a, 430b, and 430n, respectively, and still in communication with the controller 434.

The controller 434 includes a memory 436 representing one or more memory circuits that store(s) executable code or executable instructions. The controller 434 further includes a processor 438 representing processing circuitry in the form of a central processing unit, a programmable logic control circuit, and/or an application-specific integrated circuit. The processor 438 is designed to execute the instructions/code stored on the memory 436. For example, the processor 438 can use instructions stored on the memory 436 to actuate (i.e., open and close) the control valves 404a, 404b, and 404n. When the controller 434 opens the control valves 404a, 404b, and 404n, the gas 440 passes through the fuel cell assemblies 402a, 402b, and 402n, respectively, to purge the fuel cells 430a, 430b, and 430n. The gas 440 may include hydrogen, as a non-limiting example. Further, the controller 434 is designed to independently actuate the control valves 404a, 404b, and 404n. In this manner, the fuel cells 430a, 430b, and 430n can be independently purged.

Additionally, the processor 438 can be used to send instructions stored on the memory 436 to obtain data from the one or more sensors 432a, 432b, and 432n in a manner previously described. Accordingly, the controller 434 can adaptively purge each of the fuel cells 430a, 430b, and 430n in an independent manner. For example, the time delay between consecutive purge events for each of the fuel cells 430a, 430b, and 430n can be different from each other, or two or more of the fuel cells 430a, 430b, and 430n may include the same time delay between consecutive purge events based on data form the one or more sensors 432a, 432b, and 432n. Beneficially, the fuel cell assemblies 402a, 402b, and 402n can be independently managed, which may increase efficiency of the hardware of the controller 434 (i.e., the processor 438) and/or conserve the gas 440.

Alternative to, or in combination with, the time delay between consecutive purge events, the duration of a purge event can be adaptively adjusted. For example, the controller 434 use data from the one or more sensors 432a, 432b, and 432n to determine the duration of the purge event for a subsequent purge event for the fuel cells 430a, 430b, and 430n, respectively. By further adaptively controlling the control valves 404a 404b, and 404n to decrease the purge duration, the gas 440 may be conserved. Alternatively, by further adaptively controlling the control valves 404a 404b, and 404n to increase the purge duration, the fuel cell assemblies 402a, 402b, and 402n are operated more efficiently to promote increased energy output and/or are prevented from damage.

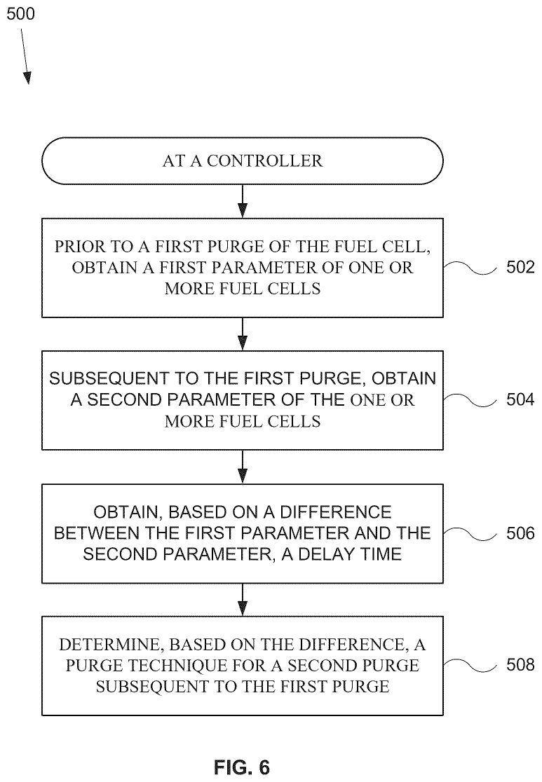

Referring to FIG. 6, a method 500 for adaptively purging a fuel cell is shown. The various steps of the method 500 may be carried out by a controller of a fuel system shown and described herein.

At step 502, prior to performing a first purge, a first parameter of the fuel cell is obtained. A “purge” represents an event in which gas (e.g., purge gas) is permitted to enter and remove unwanted liquid (e.g., water) and gas (e.g., nitrogen). The first parameter of the fuel cell may be measured/monitored by a sensor. As non-limiting examples, the sensor may include a voltmeter, a temperature sensor, a barometric sensor, an altimeter, a humidity sensor, a gas analyzer, or a hydration sensor. The controller can obtain, from the sensor, data related to the first parameter.

At step 504, subsequent to performing the first purge, a second parameter of the fuel cell is obtained. Similar to the first parameter, the controller can obtain, from the sensor, data related to the second parameter. Also, the same sensor used to measure/monitor the first parameter can be used to measure/monitor the second parameter.

At step 506, a difference between the first parameter and the second parameter is obtained. The difference may include a subtraction of a first parameter value of the first parameter from a second parameter value of the second parameter. Alternatively, the difference may include a deviation from an ideal parameter (or ideal range of parameters) as determined form a curve/plot.

At step 508, a time delay is determined, based on the difference, for a second purge subsequent to the first purge. The time delay can represent the time subsequent to the first purge when the controller will initiate the second, or next, purge to be performed.

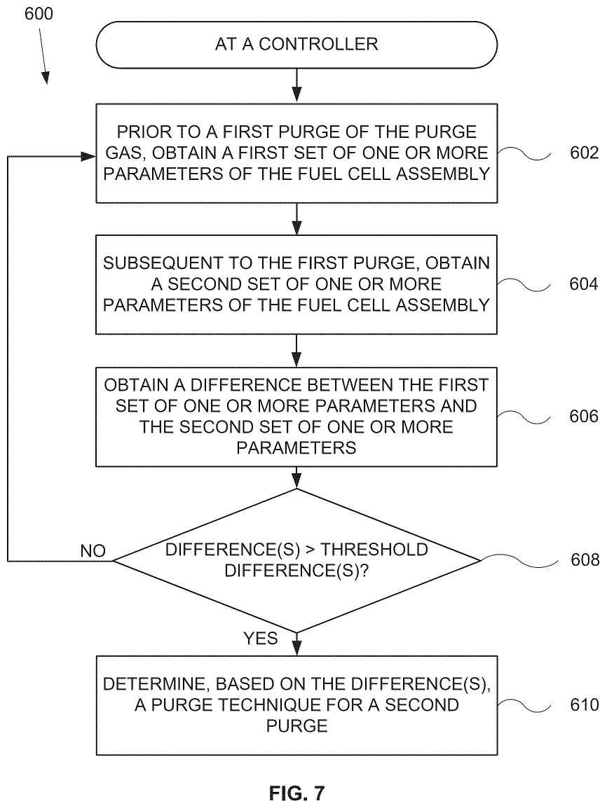

Referring to FIG. 7, a method 600 for adaptively purging a fuel cell is shown. The various steps of the method 600 may be carried out by a controller of a fuel system shown and described herein.

At step 602, prior to a first purge, a first parameter of one or more fuel cells is obtained. A “purge” represents an event in which gas (e.g., purge gas) is permitted to enter and remove unwanted liquid (e.g., water) and gas (e.g., nitrogen). When at least two fuel cells are present, the fuel cells represents a fuel stack. In this regard, one or more sensors can be used to monitor selected fuel cells or all of the fuel cells. In some exemplars, the end cells of the fuel stacks are monitored by the one or more sensors.

At step 604, subsequent to the first purge, a second parameter of one or more fuel cells is obtained. Similar to the first parameter, the controller can obtain, from the sensor, data related to the second parameter. Also, the same sensor used to measure/monitor the first parameter can be used to measure/monitor the second parameter.

At step 606, a difference between the first parameter and the second parameter is obtained. When at least two fuel cells are present, a difference between the first and second parameters for each of the fuel cells.

At step 608, a determination is made whether the one or more differences is greater than a threshold difference (or set of threshold differences). When at least two fuel cells are present, a determination is made whether each difference is above or below a predetermined threshold difference. When the difference is below the predetermined threshold difference, the method 600 returns to step 602 and a new first parameter is determined prior to a purge. Further, the controller may not implement a new time delay for a subsequent purge of the fuel cell when the predetermined threshold difference is not exceeded. When the difference is above the predetermined threshold difference, the method 600 proceeds to step 610. When at least two fuel cells are present, the controller can independently manage each fuel cell such that each fuel cell can be evaluated and independently advanced in the method 600.

At step 610, a time delay for a second purge is determined based on the difference(s). The time delay can represent the time subsequent to the first purge when the controller will initiate the second, or next, purge to be performed. When at least two fuel cells are present, a time delay can be independently determined for each fuel cell based upon evaluation of the respective first and second parameters.

Various examples of aspects of the disclosure are described below as clauses for convenience. These are provided as examples, and do not limit the subject technology or limit what the skilled artisan or one of ordinary skill in the art would understand as the scope of the disclosure and claims.

Clause A: A fuel cell system includes: a fuel cell assembly comprising an anode exhaust and a fuel cell; a valve configured to exhaust a purge gas from the anode exhaust; and a valve controller configured to: prior to a first purge of the fuel cell with the purge, obtain a first parameter of the fuel cell; subsequent to the first purge, obtain a second parameter of the fuel cell; obtain a difference between the first parameter and the second parameter; and determine, based on the difference, a time delay for a second purge subsequent to the first purge.

Clause B: A method for adaptively purging a fuel cell includes: prior to performing a first purge, obtaining a first parameter of the fuel cell; subsequent to performing the first purge, obtaining a second parameter of the fuel cell; obtaining a difference between the first parameter and the second parameter; and determining, based on the difference, a time delay for a second purge subsequent to the first purge.

One or more of the above clauses can include one or more of the features described below. It is noted that any of the following clauses may be combined in any combination with each other, and placed into a respective independent clause, e.g., clause A or B.

Clause 1: wherein: the first parameter comprises a first output voltage of the fuel cell, and the second parameter comprises a second output voltage of the fuel cell.

Clause 2: wherein: the first parameter comprises a first temperature of the fuel cell, and the second parameter comprises a second temperature of the fuel cell.

Clause 3: wherein: the first parameter comprises a first current of the fuel cell, and the second parameter comprises a second current of the fuel cell.

Clause 4: wherein: the first parameter comprises a first current of the fuel cell, and the second parameter comprises a second current of the fuel cell.

Clause 5: wherein: the first parameter comprises a first altitude or a first humidity of the fuel cell, and the second parameter comprises a second altitude or a second humidity, respectively of the fuel cell.

Clause 6: wherein the valve controller is configured to perform a second purge at a time equal to the time delay.

Clause 7: wherein the difference is inversely proportional to the time delay.

Clause 8: wherein the valve controller is configured to set the time delay to zero when the difference is below a threshold difference.

Clause 9: wherein: obtaining the first parameter comprises measuring a first output voltage of the fuel cell, and obtaining the second parameter comprises measuring a second output voltage of the fuel cell.

Clause 10: wherein: obtaining the first parameter comprises measuring a first temperature of the fuel cell, and obtaining the second parameter comprises measuring a second temperature of the fuel cell.

Clause 11: wherein: obtaining the first parameter comprises measuring a first temperature of the fuel cell, and obtaining the second parameter comprises measuring a second temperature of the fuel cell.

Clause 12: wherein: obtaining the first parameter comprises measuring a first current of the fuel cell, and obtaining the second parameter comprises measuring a second current of the fuel cell.

Clause 13: further comprising performing, at the purge time delay, the second purge.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an exemplar, the exemplar, another exemplar, some exemplars, one or more exemplars, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any exemplar described herein as “exemplary” or as an “example” is not necessarily to be construed as preferred or advantageous over other exemplars. Furthermore, to the extent that the term “include”, “have”, or the like is used in the disclosure or the claims, such term is intended to be inclusive in a manner similar to the term “comprise” as “comprise” is interpreted when employed as a transitional word in a claim.

What is claimed is:

1. A fuel cell system, comprising:
a fuel cell assembly comprising an anode exhaust and a fuel cell;
a valve configured to exhaust a purge gas from the anode exhaust; and
a valve controller configured to:
prior to a first purge of the fuel cell with the purge gas, obtain a first parameter of the fuel cell;
subsequent to the first purge, obtain a second parameter of the fuel cell;
obtain a difference between the first parameter and the second parameter; and,
determine, based on the difference, a time delay for a second purge subsequent to the first purge.

2. The fuel cell system of claim 1, wherein:
the first parameter comprises a first altitude or a first humidity of the fuel cell, and
the second parameter comprises a second altitude or a second humidity, respectively of the fuel cell.

3. The fuel cell system of claim 1, wherein:
the first parameter comprises a first temperature of the fuel cell, and
the second parameter comprises a second temperature of the fuel cell; and,
wherein the valve controller is configured to perform the second purge at a time equal to the time delay.

4. The fuel cell system of claim 1, wherein the difference is inversely proportional to the time delay.

5. The fuel cell system of claim 4, wherein:
the first parameter comprises a first current of the fuel cell, and
the second parameter comprises a second current of the fuel cell.

6. The fuel cell system of claim 1, wherein:
the first parameter comprises a first output voltage of the fuel cell, and
the second parameter comprises a second output voltage of the fuel cell.

7. The fuel cell system of claim 1, wherein the first parameter comprises a first temperature of the fuel cell, and
the second parameter comprises a second temperature of the fuel cell.

8. The fuel cell system of claim 1, wherein the valve controller is configured to:
the first parameter comprises a first temperature of the fuel cell, and
the second parameter comprises a second temperature of the fuel cell.

9. The fuel cell system of claim 1, wherein the valve controller is configured to set the time delay to zero when the difference is below a threshold difference.

10. A method for adaptively purging a fuel cell, the method comprising:
prior to performing a first purge, obtaining a first parameter of the fuel cell;
subsequent to performing the first purge, obtaining a second parameter of the fuel cell;
determining, based on a difference between the first parameter and the second parameter, a purge delay time; and,
performing, at the purge time delay, a second purge subsequent to the first purge.

11. The method of claim 10, wherein:
obtaining the first parameter comprises measuring a first output voltage of the fuel cell, and;
obtaining the second parameter comprises measuring a second output voltage of the fuel cell.

12. The method of claim 10, wherein:
obtaining the first parameter comprises measuring a first temperature of the fuel cell and
obtaining the second parameter comprises measuring a second temperature of the fuel cell.

13. The method of claim 10, wherein:
obtaining the first parameter comprises measuring a first temperature of the fuel cell, and
obtaining the second parameter comprises measuring a second temperature of the fuel cell.

14. The method of claim 10, wherein:
obtaining the first parameter comprises measuring a first current of the fuel cell; and,
obtaining the second parameter comprises measuring a second current of the fuel cell.

15. The method of claim 10, wherein:
Obtaining the first parameter comprises measuring a first humidity of the fuel cell; and,
obtaining the second parameter comprises measuring a second humidity of the fuel cell.
